(19) United States
(12) Patent Application Publication
(10) Pub. No.: US 2007/0175624 A1
(43) Pub. Date: Aug. 2, 2007

(54) Device for temperature regulation/limitation in a heat generating installation

(75) Inventors: Erhard Affolter, Ursenbach (CH); Rene Joubert, Karlsruhe (DE); Josef Lelle, Baden-Baden (DE); Lothar Schafer, Ebikon (CH)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Siemens Building Technologies AG, Zurich (CH)

(21) Appl. No.: 10/550,281

(22) PCT Filed: Mar. 18, 2004
(86) PCT No.: PCT/EP04/02834

§ 371 Date: Jan. 25, 2007

(30) Foreign Application Priority Data
Mar. 24, 2003 (EP) 03006570.0

(51) Int. Cl. G05D 23/12; G05D 23/00

(52) U.S. Cl. 165/287; 236/1 H

(57) ABSTRACT

The invention relates to a device for temperature regulation/limitation in a heat generating installation, said device comprising at least one probe (Tk) that is connected to a regulator (20) which, in turn, is connected to an automatic heating system (40) by means of a communication interface (30). The inventive device is characterised in that the automatic heating system (40) comprises a safety module (41) which compares the temperature detected by the probe, forwarded to the regulator and transmitted from the regulator to the automatic heating system by means of the communication interface, with a maximum admissible safety temperature (TSTB) stored in the safety module (41), and in that, once the safety temperature is reached or exceeded, the safety module (41) generates a cut-off signal which causes the installation to be cut off by the automatic heating system.

The invention relates to an apparatus for temperature regulation/limitation for a heat generating installation, and to a method for checking the operation in particular of the temperature regulation/limitation function for a heat generating installation.

The safety requirements for temperature regulation and limitation devices are stipulated, for example, in German Standard DIN 3440. In order to describe the invention, reference is made to the terminology used in this Standard without, however, describing the Standard in detail. According to the definition in paragraph 2.2 of the Standard, a safety temperature monitor (STW) is a device in which automatic resetting takes place after response when the sensor temperature has fallen below the selected limit value by the magnitude of the switching difference, in which case this is additionally subject to the requirements for extended safety in accordance with paragraph 3.12 of DIN Standard 3440. In contrast to a safety temperature monitor, a safety temperature limiter (STB) causes locking after response. In this case, resetting by hand or by a tool is generally possible only when the sensor temperature has fallen below the limit value by the magnitude of the switching difference.

The STB or STW mentioned initially are preferably used for monitoring the boiler temperature of a heating boiler. The boiler temperature is in this case recorded by at least one temperature sensor which, for example, can be arranged on the boiler switch panel for the heating boiler together with the temperature regulator. The temperature regulator compares the recorded temperature of the heating boiler with a predetermined nominal value, and influences the actual value of the temperature in the sense of matching it to its nominal value. When, for example, the temperature limit monitored by the temperature limiter or monitor is reached or a fault, for example, a sensor discontinuity, sensor short circuit, failure of a component or a power failure occurs, then the installation should be switched off. The installation switch-off which is triggered by the response of the STB or STW in general interrupts the power supply.

For this purpose, the control circuit or load circuit of an automatic heating system is generally interrupted, and then switches off the fuel supply. In general, the automatic heating system controls the starting procedure for the burner with initial ventilation, ignition and flame monitoring. In the event of irregularities, for example a flame failure, the automatic heating system locks the system, that is to say it interrupts the fuel supply. The automatic heating system in this case has to satisfy particular safety regulations. DIN Standard EN 298 is referred to, by way of example, as being representative of these.

The German Utility Model document DE 297 24 551 U1 discloses, for example, a control arrangement for a burner, in which the temperature sensor which is used for recording the water temperature in the heating boiler is used not only for temperature regulation but also as the safety temperature limiter. This means that there is no need for a separate temperature sensor for the safety temperature limiter, as is the case in conventional control arrangements.

In this context, a proposal has also already been made in European Patent Specification EP 0 614 047 B1 to combine the temperature monitor, the temperature regulator and the automatic heating system to form an electronic device. Since the function of the temperature monitor is also integrated in this device, there is no need for any separate thermostat. The integration of the automatic heating system, of the temperature regulator and of the temperature monitor in this case represents a cost-effective solution, since the hardware complexity can be reduced owing to the integration.

However, one precondition for this is that the combination of the burner with the automatic heating system and the heating boiler switch panel with the temperature regulator and temperature monitor is known. However, this is the exception for floor-standing heating boilers, since components from other manufacturers are also used for the combination of the boiler and burner. These components use a standardized interface (with a 4/7-pole Wieland connector) for interchanging data according to the prior art. These are provided for the 230 volt supply and control circuits. However, these allow only very restricted communication between the components.

The use of the standardized interface (Wieland connector) also has the disadvantage that if, for example, a 230 volt signal which is transmitted from the automatic heating system to the boiler switch panel and is intended to be processed further by the regulator, additionally has to be converted to an appropriate protective extra-low-voltage signal, since the regulator is generally operated with a protective extra-low voltage.

It is known from EP 0 751 350 A2 for different units of a control apparatus for heating boilers to be connected by means of a data bus, in order to interchange appropriate data between the units in the installation. This improves the data transmission capacity. The units comprising the safety temperature limiter, temperature regulator and automatic heating system are, however, in this case formed separately. In this case, components such as relays or microprocessors which carry out identical or similar tasks are in each case used for the automatic heating system and for the safety temperature limiter.

The invention is thus based on the object of proposing an apparatus in particular for use in a heating installation which, while avoiding the disadvantages that have been mentioned of the prior art, allows reliable and accurate temperature regulation/limitation with little hardware complexity, without ignoring the safety aspects.

A further object of the invention is to propose a method which allows reliable and accurate checking of the operation in particular of a temperature regulation/limitation function, in particular for a heating installation.

The stated object is achieved by the features of the independent apparatus claim and of the independent method claim. Advantageous refinements of the invention are the subject matter of the patent claims which are dependent on them.

The apparatus according to the invention or the method according to the invention can be used for all safety-relevant functions in conjunction with the monitoring of thermal processes, which ensure that, when a disturbance, a defect or a fault occurs, the installation is switched to an operationally safe state. The apparatus according to the invention is distinguished in that the safety temperature limiter or temperature monitor (STB, STW) is distributed, in terms of functionality, between the automatic heating system and the regulator. The components of the STB or STW which are subject to the extended safety requirements are in this case preferably provided in the automatic heating system. The components which are not subject to the special requirements for extended safety are preferably provided in the regulator. By way of example, the temperature comparison of the sensed actual temperature of the boiler with the maximum permissible safe temperature T_{STB} at which the STB or STW is triggered is associated with the automatic heating system. The measurement sensor for recording of the actual boiler temperature is preferably associated with the regulator. In this case, the regulator transmits the recorded actual temperature via a communication interface to the automatic heating system. The communication interface may, for example, be in the form of a data bus (electrical/optical waveguide) or of a radio link. The automatic heating system in this case monitors the boiler temperature, and, for example, disconnects the voltage from the fuel valves of the burner when the selected safe temperature T_{STB} is exceeded, thus interrupting the fuel supply.

The distribution of the functionality of the STB and STW between the regulator and the automatic heating system according to the invention means that there is no need for the previously normal mechanical STB/STW in the form of an autonomous unit, which records, assesses and monitors the boiler temperature, and if appropriate interrupts the fuel supply. As a result of the combination of the safety-relevant functions of the STB and STW in the automatic heating system, the components which are required for a safety switch-off, and preferably the components which are required for locking as well, need be provided only once. This makes it possible to considerably reduce the hardware complexity. The integration of the safety-relevant functions of the STB and STW in the automatic heating system also has the advantage that the already existing safety structures of the automatic heating system can be used synergistically in an optimum manner. Complete integration of the STB and STW in the automatic heating system is, of course, also possible.

However, this would have the disadvantage that, in this case, the temperature sensor would have to be connected to the automatic heating system, which would load the standardized automatic heating system with additional connections for the temperature sensor.

A further advantage of the invention is that the measurement value recording by the measurement sensor and the further processing of the measurement values in the regulator, and the transmission of the measurement values from the regulator to the automatic heating system, can be tested or checked by the automatic heating system according to the invention, via a communication interface. In order to allow the automatic heating system to check the temperature regulation/limitation function, an appropriate test requirement signal is preferably transmitted to a sensor/test value switching module, thus making it possible to switch between the measurement sensor resistance and a reference resistance which corresponds to it.

The sensor/test values are preferably transmitted at different times from one another. In this case, the requirements for communication interference protection must be observed. A data bus is preferably used which allows a CRC test in order to detect data transmission errors. The use of the data messages according to the invention means that there is no need for any special safety measures. For example, a data bus which complies with the safety aspects can be used for data transmission, as is described, by way of example, in the document EP 0751 350A2.

When the automatic heating system arrives at a locked state as a result of a disturbance switch-off, the safety function according to the invention for unlocking which, for example, allows a maximum of 5 unlocking operations within a specific time, allows the locking to be cancelled again by an unlocking command transmitted via the data bus. The unlocking command may in this case be produced by an appliance which is not designed to be safety-relevant, for example by the operator using a portable appliance. In order to increase the data communication safety or reliability, filtering can also be provided for the received data in the automatic heating system. This makes it possible, for example, to prevent the burner from being switched on and off inadvertently, for example.

Since the regulator according to the invention need not be designed to be safety-relevant in compliance with the Standard cited initially, no specific safety measures are required for the regulator. However, according to the invention, the automatic heating system checks the sensor, the regulator and the communication interface. DC isolation is worthwhile in this case, complying with the requirements for protective extra-low voltage, since, in contrast to the automatic heating system, the regulator is generally operated with a protective extra-low voltage. In this case, the DC isolation for the regulator or for the automatic heating system can be provided in the form of optocouplers.

Furthermore, the invention also has the advantage that further process signals can be interchanged between the automatic heating system and the regulator, for example the type of fuel, etc., via the communication interface. Further advantages of the invention will become evident from the following description.

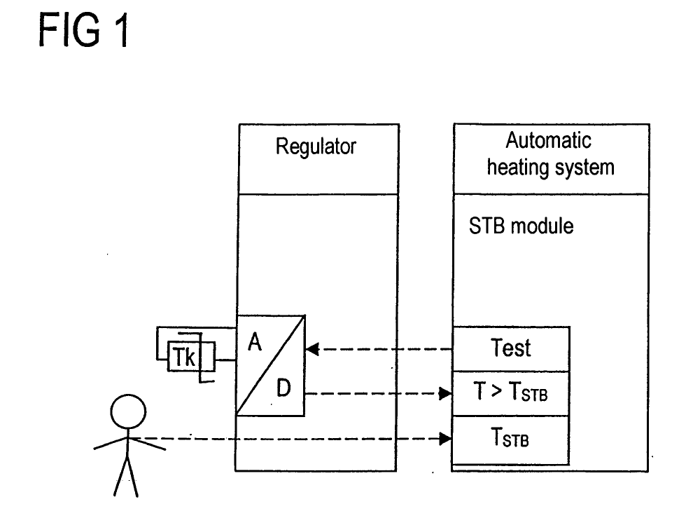

FIG. 1 shows, schematically, the arrangement according to the invention with an electronic safety temperature limiter in conjunction with a regulator and automatic heating system.

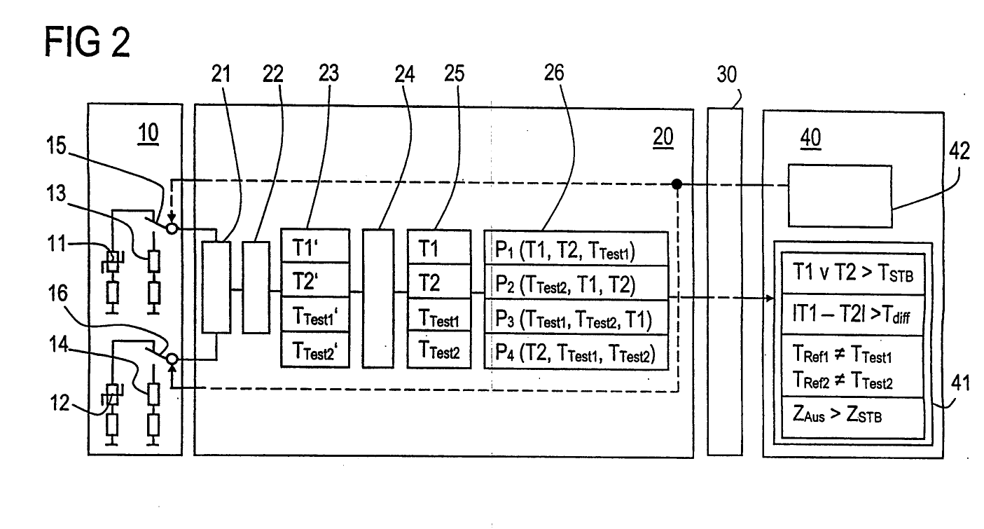

FIG. 2 uses a functional block diagram to show the preferred implementation of the invention, for example on the basis of the temperature regulation/limitation function.

FIG. 1 shows the interaction of the automatic heating system (FA) and regulator with a safety temperature limiter (STB) distributed between the regulator and the FA. The function of a safety temperature monitor (STW) can, of course, also be implemented in an appropriate manner instead of that of the electronic STB. The measurement sensor Tk is used, for example, for recording the temperature of a heating boiler, which is not illustrated here, and is connected to the regulator. The analog/digital converter of the regulator converts the analog measurement value to a digital value, for example to a temperature value T. This is transmitted from the regulator to the automatic heating system. The automatic heating system in this case has a safety module. The safety module or STB module in this case monitors, for example, the sensed boiler temperature T, and switches off the burner, which is not illustrated here, when the reference value (safe temperature T_{STB}) which is stored in the STB module is exceeded.

The safe temperature or tripping temperature T_{STB} may, for example, be set up during commissioning of the installation by a fitter via a control unit, which is not illustrated here. The safe temperature T_{STB} is in this case transmitted to the automatic heating system, and is stored as being safety-relevant, for example in the STB module. The safe temperature T_{STB} is preferably transmitted in the same format as the boiler actual temperature T to the automatic heating system.

The STB module according to the invention carries out an appropriate test in order to check the correct operation of the measurement value recording, of the regulator and of the communication interface. By way of example, the measurement sensor and the path from the sensor connecting terminal including the further processing in the regulator, for example analog/digital conversion, are checked, as well as the transmission of the converted measurement value from the automatic heating system. A check is also carried out to determine whether the measurement value T is within the permissible range defined by T_{STB}.

The appropriate requirements for interference protection of the data transmission must be observed for the communication between the regulator and the automatic heating system, in order that the fundamental safety is guaranteed and unnecessary spurious switch-offs do not occur. In the event of a failure of the sensor or a fault in the regulator or a communication disturbance, a safety switch-off is carried out by the automatic heating system, to be precise until the defect or fault has been rectified. The various models for handling faults or defects will be described in the following text.

FIG. 2 shows one preferred exemplary embodiment of the implementation of the method for checking a temperature regulator/limiter function, in which the safety-relevant functions are carried out by the automatic heating system. The regulator 20 and the automatic heating system 40 are connected to one another via a communication interface (30), as illustrated here.

A data bus (electrical/optical) or else a wire-free radio link may be used, for example, as the communication interface between the regulator and automatic heating system. A sensor value/test value switching module 10 is preferably driven by a test requirement signal from the automatic heating system.

The temperature sensor resistances 11 and 12 are used, for example, for recording the actual value temperature of a heating boiler which is not illustrated here. The reference resistances 13 and 14 are connected in parallel with them, via the switches 15 and 16. This allows switching between the measurement sensor resistances 11 and 12 and the reference resistances 13 and 14, thus resulting in sensor values or reference/test values. The elements 11 to 16 which are associated with the sensor value/test value switching module 10 may, of course, be provided partially or else entirely in the regulator 20, corresponding to the functionality.

The duplication of the temperature sensor, for example an NTC sensor, makes it possible, for example, to identify that the temperature sensor is mounted correctly or that a short circuit or sensor discontinuity has occurred, by comparison of the temperature sensor resistances and of the sensor values. This redundant configuration of the temperature sensor is thus a worthwhile safety measure. Age-dependent drifting of the sensor value can also be detected by comparison with the reference resistances or reference values which correspond to them. It is, of course, also possible to provide a double sensor or else only one temperature sensor instead of two separate individual sensors. In this case, only one reference resistance need be provided. In this case, it is necessary to ensure that reliable and safe sensor location and operation of the sensor are guaranteed. This also applies to the reference sensor and reference resistance, of course.

If the reference switching does not operate without faults or a short-circuit or discontinuity occurs in a reference resistance, then this can be identified by the reference/test values. The sensor/test values T1′ and T2′ or T_{Test 1′} and T_{Test 2′} are, for example, supplied from a multiplexer 21 to an analog/digital converter 22. In this case, the test values can also be used to identify faults in the multiplexing process or in the analog/digital conversion process. The converted temperature values T1′ and T2′ as well as the converted test values T_{Test 1′} and T_{Test 2′} are, for example, in hexadecimal form, and are supplied to a shift register 23. The sensor and test values which are temporarily stored in the register 23 are then preferably supplied to a linearization module 24 which, for example, has software in order to linearize the characteristic.

In this case, the sensor/test values which, for example, are in hexadecimal form in the register 23 are changed to a form which is suitable for evaluation, for example to integer values. The sensor/test values T1, T2, T_{Test1} and T_{Test2} which are produced by the linearization process are supplied, for example, to a shift register 25. The shift registers in this case preferably have a ring structure. Since the last value from the temporary storage of the sensor/test values in the shift registers is rejected, this ensures that the sequence of the sensor/test values in the corresponding memory cells in the shift register changes.

A test requirement signal, for example a test actuation sequence, is, for example, preferably transmitted every 10 seconds asynchronously from a test requirement unit (42) for the automatic heating system to the sensor value/test value switching module (10). The test requirement module 42 may, of course, also be contained in the safety module 41. Switching then takes place from the sensor resistances to the reference resistances. The automatic heating system then appropriately evaluates the response signal, received within a defined time interval, in order to check operation in terms of faults or defects that have occurred in the installation. By way of example, the asynchronicity between the sensor/test values can also be evaluated by the automatic heating system.

The response to the test requirement can additionally be identified by a specific attribute. This makes it possible to simplify the evaluation of the response by the automatic heating system. By way of example, a current time indication can be used as an attribute for identification of the response to the test requirement. Alternatively, it would also be possible to use a random value generated by the regulator, which is subsequently checked by the automatic heating system.

The sensor/test values are preferably transmitted for example in accordance with the protocol and for example in the form of a data message. An appropriate transmitter buffer 26, for example, may be provided for this purpose. One of the four data messages P₁ to P₄ for transmission to the automatic heating system is, for example, provided in the transmission buffer. The messages P₁ and P₂ are in each case preferably transmitted periodically, for example every 5 seconds, from the regulator to the automatic heating system, automatically.

The message P1 comprises, for example, the sensor values T1, T2, and the test value T_{Test1}. The message P₂ comprises, for example, the test value T_{Test2} and the sensor value T1 and the sensor value T2. The messages P₃, P₄ may, for example, each be transmitted as a response to the test requirement, preferably asynchronously with respect to the messages P₁ and P₂. The message P₃ comprises, for example, the two test values T_{Test1}, T_{Test2} and the sensor value T1. The message P₄ comprises, for example, the sensor value T2 and the two test values T_{Test1}, T_{Test2}

The automatic heating system (40) or the safety module (41) can then carry out the check of the temperature regulation/limitation function on the basis of the received data messages P₁, P₂, P₃ or P₄. The various test functions are described in the following text. The automatic heating system first of all tests the correct sequence of the messages P₁ to P₄. For example, the burner is prevented from restarting if the correct test sequence is not detected.

The test functions illustrated in the functional block diagram will be described in the following text. A different sequence than that described here may, of course, also be used for the test functions.

The first test function includes the check of the two temperature values T1 and T2, which for this purpose are compared with the trigger temperature of the safety temperature limiter T_{STB}. On reaching or exceeding T_{STB}, a fault message is generated, and the burner is switched off by the automatic heating system. In this case, locking also takes place, if a switch-on command from the regulator to the automatic heating system is present at the same time.

In the case of the second test function, the sensor values T1 and T2 are each compared with a maximum permissible temperature difference T_{diff}. If, by way of example, this temperature difference is permanently exceeded, the automatic heating system locks the burner and generates an appropriate fault message. If the temperature difference is exceeded briefly or once, just one safety switch-off may also take place. However, if the maximum permissible temperature difference is exceeded once or more within a specific time, then the automatic heating system locks the burner.

The third test function includes a comparison of the reference values T_{Ref1} and T_{Ref2}, as derived by way of example from the reference resistances, with the test values T_{Test1} and T_{Test2}.

If, by way of example, the comparison result does not in this case correspond to an expected value, then the automatic heating system switches off the burner, and a fault message is generated. If there is no response to the test requirement it is possible, for example, for the reference resistance or the regulator to have failed, or for there to be a communication disturbance. In this case, for example, the automatic heating system can lock the burner after a time delay.

The fourth function comprises, for example, an overtemperature counter in order to detect when the safe temperature T_{STB} is subsequently still exceeded as a result of a subsequent heating effect after the burner has been switched off. A corresponding counter is incremented if this is the case. If, for example, the count Z_{off} has reached a predetermined value Z_{STB}, locking takes place.

If the automatic heating system or the STB module locks the burner after a fault switch-off, then this could be unlocked by an unlocking command. The unlocking command may in this case also be produced by a controller which is not designed to be safety-compliant. In this case, error-free data transmission of the unlocking command via the data bus must be ensured. A CRC error check may be used, for example, for this purpose. Furthermore, no further special safety measures need be provided for data transmission of the unlocking command.

The unlocking function will be described in the following text. When a fault occurs in the automatic heating system with locking which has been emitted as a fault message from the automatic heating system to the data bus and is indicated on the controller, the operator can, for example, select a menu provided for unlocking purposes on the controller. The unlocking command is then passed from the operator to the data bus via the controller. The unlocking process then takes place. In order to avoid incorrect actions, the unlocking function is preferably carried out using a handshake process. By way of example, the controller which initiates the unlocking command may have to wait for a specific time to determine whether the unlocking has been successfully carried out.

If the information that the unlocking was successful does not appear, then, for example, another attempt to carry out the unlocking process may be allowed, for example, once a time delay has elapsed.

With regard to unlocking, a distinction may be drawn, for example, between three unlocking classes. The first class relates, for example, to internal faults in the automatic heating system, which can be reset only after cancellation of an unlocking inhibit. In a situation in which the unlocking is inhibited, the inhibit can be cancelled, for example, only by means of a mains on/off switch or by means of a specific unlocking key, for example by means of an unlocking key on the boiler switch panel, by means of a separate data line. The inhibiting and the unlocking can be notified to the operator by an appropriate indication.

The second class relates, for example, to faults in the heating installation, in which the STB function has been triggered. The locking can in this case be reset by the operator, for example just once, by means of an unlocking command which is sent via the data bus.

The third class relates to other application faults which, for example, can be reset via a controller. A safety function is preferably used for this purpose which, for example, allows a maximum of 5 unlocking operations within a defined time. The safety function is in this case effective only for unlocking via the data bus.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. An apparatus for temperature regulation/limitation of a heat generating installation, the apparatus comprising:
a first measurement sensor;
a regulator operatively connected to the first measurement sensor;
an automatic heating system including a safety module; and
a communication interface operatively connecting the automatic heating system to the regulator;
wherein the safety module stores a maximum permissible safe temperature value, the first measurement sensor detects a temperature and transmits a corresponding temperature signal to the regulator, the regulator receives the temperature signal and transmits a corresponding temperature indication to the automatic heating system via the communication interface, the safety module compares the temperature indication to the maximum permissible safe temperature value, the safety module generates a switch-off signal when the temperature indication at least one of equals and exceeds the maximum permissible safe temperature value, and the switch-off signal causes the automatic heating system to switch off the heat generating installation.

18. The apparatus as claimed in claim 17, further comprising:
a second measurement sensor operatively connected to the regulator.

19. The apparatus as claimed in claim 17, further comprising:
a sensor value/test value switching module including a switch which connects a reference resistance in parallel with a measurement sensor resistance;
wherein the automatic heating system controls switching between the measurement sensor resistance and the reference resistance.

20. The apparatus as claimed in claim 19, wherein the automatic heating system includes a test requirement unit configured to transmit a test requirement signal to the sensor value/test value switching module, and the sensor value/test value switching module is configured to transmit a test value derived from the reference resistance to the automatic heating system via the communication interface in response to the test requirement signal.

21. The apparatus as claimed in claim 20, wherein the regulator processes at least one of a measurement value derived from the measurement sensor resistance and the test value before the regulator transmits the at least one of the measurement value and the test value to the automatic heating system via the communication interface.

22. The apparatus as claimed in claim 21, wherein the regulator includes a multiplexer operatively connected to the switch, an analog/digital converter operatively connected to the multiplexer, a shift register operatively connected to the analog/digital converter, and a linearization module operatively connected to the shift register;
thereby providing for further processing of the at least one of the measurement value and the test value.

23. The apparatus as claimed in claim 17, wherein the communication interface includes at least one of a data bus or a radio link.

24. A method for checking the operation in particular of the temperature regulation/limitation function for a heat generating installation, which has at least one measurement sensor, a regulator, a communication interface and an automatic heating system with the measurement values which are derived from at least one measurement sensor being passed on to the regulator for further processing and being transmitted via the communication interface to the automatic heating system, comprising:
comparing the received measurement values with a maximum permissible safe temperature via the automatic heating system; and
generating a switch-off signal on reaching or exceeding the maximum permissible safe temperature.

25. The method as claimed in claim 24, further comprising:
generating a test requirement signal for at least one of functional checking of a measurement value recording, further processing of the measurement values, and transmission of the measurement values from the automatic heating system;
receiving a response to the test requirement via the automatic heating system within a defined time period; and
evaluating the response via the automatic heating system.

26. The method as claimed in claim 25 further comprising:
providing the response to the test requirement with a specific attribute.

27. The method as claimed in claim 25, further comprising:
generating the response to the test requirement signal by comparing test values with reference values.

28. The method as claimed in claim 27, further comprising:
locking a burner after a time delay via the automatic heating system if a comparison between a reference value and the test values does not correspond to an expected value;
locking a burner after a time delay via the automatic heating system if a fault message is generated;
locking a burner after a time delay via the automatic heating system if a lack of the response to the test requirement signal indicates a failure of at least one of the measurement sensor resistance/reference resistance and the regulator; and
locking a burner after a time delay via the automatic heating system if the lack of the response to the test requirement indicates a communication fault.

29. The method as claimed in claim 24, further comprising:
comparing the received measurement values with a maximum permissible temperature difference;
initiating a safety switch-off via the automatic heating system once the received measurement values first exceed the maximum permissible temperature difference; and
locking a burner via the automatic heating system if the received measurement values again exceed the maximum permissible temperature difference within a specific time after the received measurement values first exceed the maximum permissible temperature difference.

30. The method as claimed in claim 24, further comprising:
incrementing a counter when the maximum permissible safe temperature is exceeded as a result of a subsequent heating effect after a burner has been switched off; and
locking the burner via the automatic heating system when the counter reaches a predetermined maximum permissible limit value.

31. The method as claimed in claim 24, further comprising:
limiting unlocking operations via the communication interface to a maximum number of unlocking operations within a defined time period.

32. The method as claimed in claim 24, further comprising:
transmitting the sensor and test values as a data message periodically and automatically from the regulator to the automatic heating system; and
checking the transmitting of the sensor and test values via the automatic heating system.

33. The method as claimed in claim 24, further comprising:
transmitting the sensor and test values asynchronously to the automatic heating system as a response to a requirement from the automatic heating system; and
checking the transmitting of the sensor and test values via the automatic heating system.
